(19) United States
(12) Patent Application Publication
(10) Pub. No.: US 2005/0125248 A1
(43) Pub. Date: Jun. 9, 2005

(54) Method for deploying vehicle transport covers

(76) Inventors: Frank L. Butterworth III, Upland, IN (US); Alice M. Butterworth, Marion, IN (US)

Correspondence Address: EDWARD D. GILHOOLY, 28 E. JACKSON BLVD., SUITE 423, CHICAGO, IL, 60604, US

(21) Appl. No.: 10/983,209

(22) Filed: Nov. 5, 2004

Related U.S. Application Data
(60) Provisional application No. 60/517,591, filed on Nov. 5, 2003.

(51) Int. Cl. G06F 17/60

(52) U.S. Cl. 705/1; 705/8

(57) ABSTRACT

The present invention relates to a system of deploying a washable vehicle cover that provides for the cover to be refurbished and re-used as a new cover. Specifically, the system of the present invention deploys a washable cover by first sending the cover to a vehicle manufacturer for protecting the shipment of the vehicles from the manufacturer. The manufacturer sends the covered vehicle to a destination where the cover is removed, and sends the used cover to the cover supplier. The cover supplier inspects and repairs any damage to the cover, then washes the cover so that the cover is as suitable for re-use as a new cover. Finally, the washed cover is sent to the manufacturer to repeat the cycle.

### BACKGROUND OF THE INVENTION

1. Field of Invention

The present invention pertains to systems and methods for deploying vehicle transport covers.

2. Description of the Related Art

During the shipment and/or transport of vehicles from one location to another the vehicles may be exposed to a variety of environmental pollutants that may damage the painted surface of the vehicle. Such environmental pollutants include industrial fallout, acid rain, smoke, soot, oil, bird droppings, sand, tar, road debris, ultraviolet sunlight degradation, salty ocean spray and swarf. In addition, abrasive objects, such as keys, watches, rings, and other jewelry worn by the vehicle handlers, may come into contact with the painted exterior causing unsightly scratches and chips in the vehicle finish. As a result, the vehicle may reach the consumer in a marred and unacceptable condition, which can ultimately result in costly repairs.

A variety of vehicle protection devices have been developed to prevent damage to the vehicle's finish during transport. One such device comprises a plastic sheeting film that is applied to the hood and various portions of the side panels of the vehicle. Unfortunately, the application and removal of this plastic sheeting film can be difficult and time consuming, thus resulting in substantial labor costs. Furthermore, the plastic sheeting is typically disposable and cannot be re-used, thus resulting in increased waste.

Other such vehicle protection devices comprise a cover that completely or partially overlays the vehicle. These covers can be made from a moisture-resistant fabric and may include openings for headlights, taillights, and/or windows. The covers are typically secured to the vehicle using straps, plastic buckles, hook and loop fasteners, elastic and the like. The covers may also provide a means for allowing entry into the vehicle without removing the cover. One such cover is described in U.S. Pat. No. 6,099,067 to Butterworth entitled Vehicle Transport Cover, assigned to the assignee of the present invention, the disclosure of which is explicitly incorporated by reference herein. Some of these covers, including those described in the Butterworth '067 patent, are reusable and can be easily removed from one vehicle and installed over another vehicle. In typical use, the cover is applied to the vehicle at its origination location. The covered vehicle is then transported to its destination location by ship, truck and/or other means. Once the vehicle reaches its destination location, the cover is removed and may be returned to the origination location for re-use, alternatively the covers may be destroyed or recycled.

Usually, the vehicle manufacturer or transporter purchases the transport covers for use in protecting the vehicles during transit. Unfortunately the vehicle manufacturer and/or transporter is usually not equipped to attend the covers after use. Consequently, the vehicle transporter may discard the cover by destroying or recycling the cover, thus requiring the vehicle transporter to incur the additional expenses of buying new covers. Alternatively, the vehicle transporter or vehicle receiver must ship the covers back to the origination location for re-use. Thus, in order to continue transporting vehicles, the vehicle transporter must either own a large pool of covers, which may be relatively expensive, or wait to receive the used covers before transporting the next batch of vehicles.

Although vehicle transport covers, such as those described the Butterworth '067 patent, have proven successful at protecting vehicles from damage during shipment, a need remains for an improved method of deploying vehicle transport covers.

### SUMMARY OF THE INVENTION

The present invention relates to a system of deploying a washable vehicle cover that provides for the cover to be refurbished and re-used as a new cover. Specifically, the system of the present invention deploys a washable cover by first sending the cover to a vehicle manufacturer for protecting the shipment of the vehicles from the manufacturer. The manufacturer sends the covered vehicle to a destination where the cover is removed, and sends the used cover to the cover supplier. The cover supplier inspects and repairs any damage to the cover, then washes the cover so that the cover is as suitable for re-use as a new cover. Finally, the washed cover is sent to the manufacturer to repeat the cycle.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a flow chart schematically representing a method of marketing vehicle transport covers according to the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE INVENTION

The embodiments hereinafter disclosed are not intended to be exhaustive or limit the invention to the precise forms disclosed in the following description. Rather the embodiments are chosen and described so that others skilled in the art may utilize its teachings.

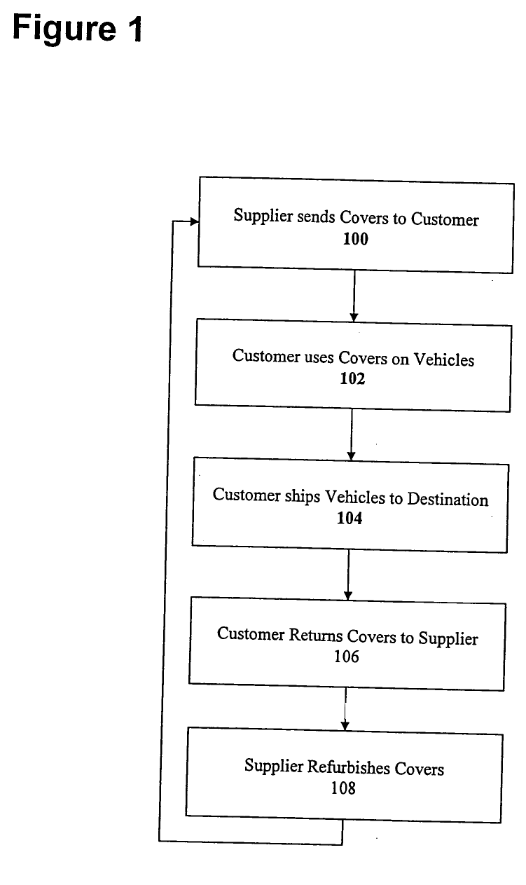

The present invention provides a method for deploying re-usable vehicle transport covers. In addition to simply selling the covers, the method of the present invention generally contemplates selling the services of lending, refurbishing and recycling the re-usable vehicle covers. The method of the present invention generally includes the steps of receiving a customer's order for covers, distributing the vehicle covers to the customer, receiving used vehicle covers from the customer, and refurbishing the used vehicle covers for re-distribution as generally depicted in FIG. 1. Thus the charges and payments for the covers may be based on the sale of the covers, the service of refurbishing, the service of providing covers, or combination of these and other payment models.

The customer initially requests a certain number of vehicle covers by submitting an order to the vehicle cover supplier. The customer is typically the vehicle manufacturer, however the present invention may be utilized by any organization which desires to cover its vehicles with a protective cover. The present invention may also be practiced wholly by a manufacturer, namely with an internal portion of the manufacturing organization providing the covers to the manufacturing or shipping portion of the organization as appropriate. Therefore, in the present disclosure, although certain actors in the process are labeled as “supplier” or “customer” the intent of the disclosure is to illustrate the invention and not limit it to transactions between separate organizations.

When placing the order, the customer provides the cover supplier with demographic information such as the cover delivery address, return container delivery address, billing address, size of vehicles and/or size of covers needed, and the number of covers needed. The customer's order may be submitted to the cover supplier using any appropriate means of communication, including phone, fax, e-mail, internet, or the like. In one embodiment, the demographic information is provided by completing a form found on-line at an internet web-site. In another embodiment, the customer completes a paper hard-copy form and mails or faxes it to the cover supplier. In still another embodiment, an electronic form is completed and e-mailed to the cover supplier.

The number of vehicle covers requested by the customer may be based on monthly, weekly, daily or annual needs. Similarly, the distribution of the vehicle car covers may be requested in intervals, such as monthly, weekly, biennial, quarterly or annually. For example, the customer may require 600 vehicle covers per year, but may request that the 600 vehicle covers be distributed in monthly increments of 50 vehicle covers per month.

Once the order is received, the cover supplier then distributes the requested number of vehicle covers to the cover delivery address. The cover delivery address is the location to which the customer directs the delivery of the vehicle covers, and will likely be the vehicle origination point or the location whereat the vehicle cover will be installed on the vehicle. However, in some cases, the customer may direct delivery of the vehicle covers to another location, such as a distribution center or storage facility. This general step is shown as step 100 in FIG. 1.

The cover supplier also distributes to the customer one or more return shipping containers or labels, in or with which one or more vehicle covers may be shipped back to the supplier after use. The shipping containers may be any container suitable for shipping vehicle covers and may be sized to receive either a single vehicle cover or multiple vehicle covers. These return shipping containers are distributed to the return container delivery address designated by the customer. The customer may indicate that the return container delivery address is the same as the cover delivery address, in which case the return shipping containers may be shipped along with the vehicle covers. In other cases, the customer may indicate that the return container delivery address is the location where the vehicle cover will be removed from the vehicle, which is typically the destination point of the vehicle being transported. In one exemplary embodiment, the cover supplier may put a cover in a return delivery box, then put the return delivery box in another container addressed to the customer. The customer would then open the delivery box to get to the typically unsealed return box. The cover would then be removed from the delivery box, the delivery box placed in the vehicle interior, and the cover deployed on the vehicle.

The customer installs the vehicle cover on the vehicle (step 102) and transports the vehicle to its destination (step 104). The used cover is then removed from the vehicle, packaged in the return shipping container, and shipped back to the cover supplier (step 106).

When the cover supplier receives the used vehicle covers the supplier refurbishes the covers for redistribution to its customers in step 108. While the returned cover may be suitable for re-use without any further processing, the cover supplier inspects the returned covers and determines what further processing is needed to complete the refurbishing step. Typically, the refurbishing process may involve inspecting, spot cleaning, mending, repairing, refinishing, and washing the covers. The resulting refurbished covers are then either immediately re-distributed (thus returning to step 100) or are returned to a stock of covers where they are stored until needed to fill another customer request.

In order to allow for the refurbishing of covers, the covers must be made of a material which is susceptible of washing and rewashing in a commercial laundry type of facility. Synthetic materials are particularly adapted to the purpose of protecting the vehicle and withstanding multiple refurbishing activities with the ability to fit the designated vehicle. Natural or mixed synthetic/natural materials may be used if they meet the rewashing in a commercial laundry criteria. Other desirable characteristics for the material of the cover include fabrics which are both stretchable and washable, such as knitted or woven fabrics. The cover may also have drivable, viewable windows and door entries such as those disclosed in the Butterworth '067 Patent.

Several charging and payment mechanisms may be used with the present invention. In one exemplary embodiment, when a customer places his first order, the supplier starts an account for the customer. When the covers are distributed to the customer the account is debited a cover lending fee based on the number of covers distributed to the customer. An invoice for the lending fee amount is sent to the billing address designated by the customer some time after the covers are distributed to the customer. The customer account may also include a tally of the number and cost of the covers delivered to and returned by the customer. If the covers are not returned in a timely manner; for example, prior to the distribution of the customer's next order, the account may be flagged. When an account is flagged, the supplier is alerted to the customer's arrears. The supplier may then investigate the matter further, may bill the customer for the actual cost of the un-returned covers, and/or may refuse to fulfill further orders. Alternatively, the cover supplier may ask for a deposit or a credit card number when the order is placed to cover the cost of the vehicle transport covers in the event that the customer does not return the covers.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method of supplying and recycling protective vehicle covers comprising the steps of
sending a vehicle cover from a supplier to a customer for use on a vehicle to be transported,
returning said vehicle cover to the supplier,
refurbishing said vehicle cover as needed, and
re-sending said vehicle cover to a customer.

2. The method according to claim 1 further comprising the step of providing the customer with a return means to return said vehicle cover during said steps of sending and re-sending said vehicle cover.

3. The method according to claim 2 wherein said return means accompanies said vehicle during said steps of sending and re-sending said vehicle cover.

4. The method according to claim 2 wherein said return means is a shipping container.

5. The method according to claim 4 wherein each said shipping container is pre-addressed for return to the supplier.

6. The method according to claim 2 wherein the customer locates said vehicle cover on a vehicle prior to shipment to a destination and the vehicle is returned to the supplier from the destination.

7. The method according to claim 6 wherein said return means accompanies the vehicle during transport to the destination.

8. The method according to claim 1 wherein the step of refurbishing includes the steps of making any necessary repair of said vehicle cover and cleaning of said vehicle cover.

9. A method of distributing a vehicle transport cover by a supplier for use on a vehicle during transport comprising the steps of
sending the vehicle cover to a customer for use on a vehicle during transport to a destination,
providing return means with the vehicle cover to permit return of said vehicle cover from the destination to the supplier, and
refurbishing said vehicle cover prior to being re-sent to a customer.

10. The method according to claim 9 further including the step of re-sending said vehicle cover to a customer after being refurbished.

11. The method according to claim 9 wherein said return means includes a shipping container.

12. The method according to claim 9 according to claim 9 wherein said return means includes a return delivery address.

13. The method according to claim 9 wherein said return means accompanies said vehicle cover during transport.

14. The method according to claim 9 wherein the step of refurbishing includes the step of inspecting said vehicle cover.

15. The method according to claim 9 wherein the step of refurbishing includes the step of cleaning said vehicle cover.

16. The method according to claim 9 wherein the step of refurbishing includes the step of repairing said vehicle cover.

17. The method according to claim 9 wherein the step of refurbishing includes the step of refinishing said vehicle cover.

18. A method of supplying and recycling protective vehicle covers comprising the steps of
sending a vehicle cover from a supplier to a customer for use on a vehicle to be transported,
returning said vehicle cover to the supplier,
refurbishing said vehicle cover as needed, and
re-sending said vehicle cover to a customer.

19. The method according to claim 18 further comprising the step of sending return shipping means to the customer for return of the vehicle cover during said steps of sending and re-sending said vehicle cover to a customer.

20. The method according to claim 19 wherein the customer locates vehicle cover on a vehicle for shipment to a destination.
